(19) United States
(12) Patent Application Publication
(10) Pub. No.: US 2006/0037853 A1
(43) Pub. Date: Feb. 23, 2006

(54) Solar distilling apparatus for alcohol

(76) Inventors: Tony Roan, Kaohsiung Shiann (TW); Jing-Jye Roan, Kaohsiung Shiann (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/923,526

(22) Filed: Aug. 20, 2004

(51) Int. Cl. B01D 5/00; B01D 3/10

(52) U.S. Cl. 202/186; 202/234; 202/205

(57) ABSTRACT

A distilling apparatus for alcohol includes an evaporation tank having a compartment for receiving fermented alcoholic liquid. A heating tube is mounted in the compartment for heating the fermented liquid into steam. A condensing device is communicated with the evaporation tank for receiving and condensing steam from the evaporation tank. A collecting tank is communicated with the condensing device for collecting condensed liquid from the condensing device. A negative pressure creating device creates a negative pressure in the evaporation tank, allowing the fermented alcoholic liquid in the evaporation tank to evaporate at a low temperature. A solar energy collecting device includes a solar energy collector and a water tank containing water heated by the solar energy collector. Hot water in the water tank flows into the heating tube for heating the fermented alcoholic liquid in the evaporation tank.

### BACKGROUND OF THE INVENTION

1. Field of the Invention

The present invention relates to a distilling apparatus for alcohol. In particular, the present invention relates to a solar distilling apparatus for alcohol such as liquors, wines, etc.

2. Description of the Related Art

Fermented liquids such as alcohol and vinegar without distillation contain impurities and may continue to ferment and thus become sour. For a fermented alcoholic liquid, distillation is required to remove impurities, to increase the alcoholic concentration, and to improve the flavor.

As well known in the art, in addition to improvement in quality, fermented alcoholic liquids can be preserved for a longer time after distillation. In the past, alcohol makers without professional distilling equipments used in wine factories utilized ordinary water distilling apparatuses to distill the fermented alcoholic liquids. However, the resultant alcohol is not pure, and the alcohol concentration is not uniform throughout the distillation procedure. Further, when the level of the alcoholic liquid in the distillation column is lowered to be approximately the same as that of a heater as a result of evaporation, the alcoholic liquid adjacent to the heater are heated at high temperature and thus generates a smell of char. Further, the alcoholic liquid obtained from distillation could not be rapidly cooled such that the concentration of the alcoholic liquid is lowered.

Although continuous type distilling apparatuses have been used to improve the distilling efficiency, the structures and the procedures are complicated, leading to high cost and inconvenient maintenance and operation. Further, the high heat for vaporizing the fermented alcoholic liquids burns the residue and impurities at the bottom of the fermented alcoholic liquid, adversely affecting the flavor. Further, the high heat means consumption of a considerable amount of energy.

FIG. 1 of the drawings illustrates an energy-saving distilling apparatus for alcohol. The distilling apparatus comprises an evaporation tank 1 including a compartment 11 for receiving fermented alcoholic liquid, a first condenser 2 communicated with the evaporation tank 1 for receiving steam from the evaporation tank 1, a second condenser 3 communicated with the first condenser 2 for receiving uncondensed steam from the first condenser 2, a collecting device 4 communicated with the second condenser 3 for receiving condensed liquid in batch, and a negative pressure creating device 5 communicated with the collecting device 4 for guiding flowing of the steam generated in the evaporation tank 1. The first condenser 2 condenses and collects substances having relatively high specific densities. The negative pressure creating device 5 creates a negative pressure in the evaporation tank 1 such that the evaporation tank 1 is capable of distilling fermented liquid at a lower temperature. The steam resulting from distillation is guided, condensed, and collected in batch, obtaining purer alcoholic liquid with improved flavor.

Such a distilling apparatus may filter aldehydes while saving energy. The present invention is intended to provide a further improved design in this regard.

### SUMMARY OF THE INVENTION

In accordance with an aspect of the present invention, a distilling apparatus for alcohol comprises an evaporation tank including a compartment for receiving fermented alcoholic liquid. A heating tube is mounted in the compartment for heating the fermented liquid into steam. A condensing device is communicated with the evaporation tank for receiving and condensing steam from the evaporation tank. A collecting tank is communicated with the condensing device for collecting condensed liquid from the condensing device. A negative pressure creating device creates a negative pressure in the evaporation tank, allowing the fermented alcoholic liquid in the evaporation tank to evaporate at a low temperature. A solar energy collecting device comprises a solar energy collector and a water tank containing water heated by the solar energy collector. Hot water in the water tank flows into the heating tube for heating the fermented alcoholic liquid in the evaporation tank.

The heating tube is preferably helical. The water tank includes a hot water outlet communicated with a first end of the heating tube. The water tank includes a cold water inlet communicated with a second end of the heating tube. The condensing device comprises a first condenser and a second condenser mounted between the first condenser and the collecting tank. The evaporation tank includes a steam chamber located above the compartment. The first condenser includes a helical condensing tube. The second condenser includes a water tank and a helical condensing tube mounted in the water tank.

The distilling apparatus further comprises means for circulating fermented liquid in the evaporation tank. In an embodiment of the invention, the means for circulating fermented liquid includes a pump, a first tube connected between an inlet of the pump and a bottom portion of the evaporation tank, and a second tube connected between an outlet of the pump and a top of the compartment of the evaporation tank.

The distilling apparatus further comprises a second collecting tank for collecting methyl alcohol, and the collecting tank collects ethyl alcohol.

The second collecting tank is communicated with the second condenser via a first tube. The collecting tank is communicated with the first tube via a second tube. A first control valve is mounted to a coupling point between the first tube and the second tube for providing selective communication between the second condenser and the collecting tank and between the second condenser and the second collecting tank.

The distilling apparatus further comprises a third collecting tank for collecting ethyl alcohol with a concentration lower than that in the collecting tank. The third collecting tank is communicated with the first tube via a third tube. A second control valve is mounted to a coupling point between the first tube and the third tube, providing selective communication between the second condenser and the second collecting tank and between the second condenser and the third collecting tank.

Thus, solar energy can be used to distill fermented alcoholic liquid to obtain alcohol. The consumed energy is less than that required by conventional distilling apparatuses.

Other objectives, advantages, and novel features of the invention will become more apparent from the following detailed description when taken in conjunction with the accompanying drawings.

### BRIEF DESCRIPTION OF THE DRAWINGS

FIG. 1 is a sectional view of a conventional distilling apparatus for alcohol.

FIG. 2 is a sectional view of a distilling apparatus for alcohol in accordance with the present invention.

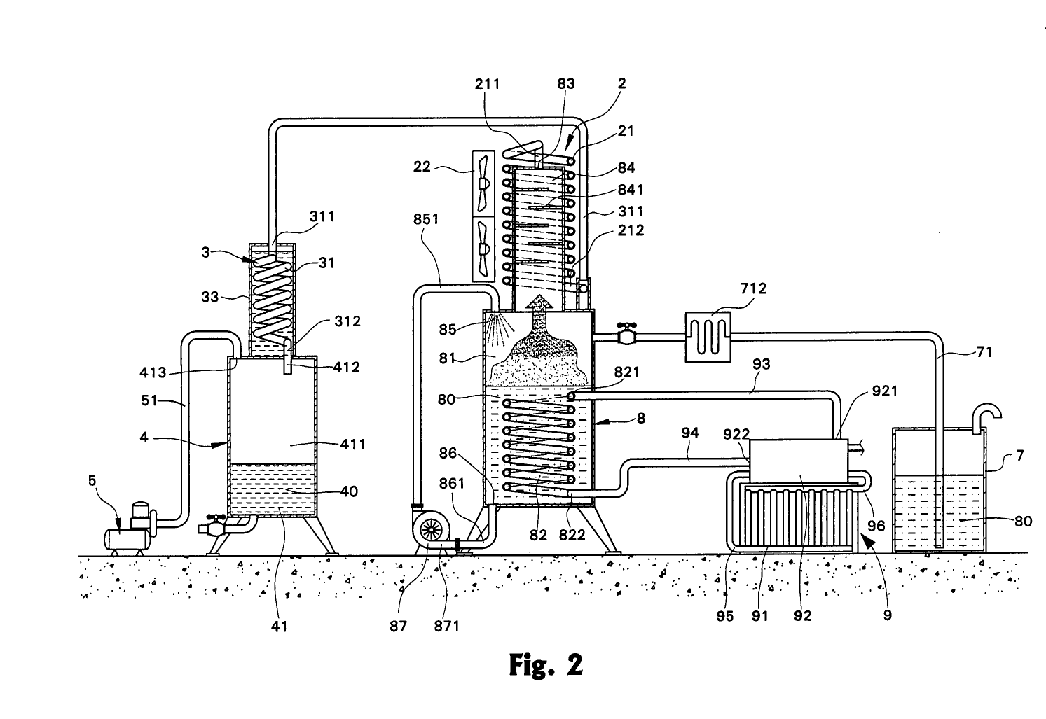

FIG. 3 is a sectional view of a modified embodiment of the distilling apparatus for alcohol in accordance with the present invention.

FIG. 4 is a sectional view of another modified embodiment of the distilling apparatus for alcohol in accordance with the present invention.

### DETAILED DESCRIPTION OF THE PREFERRED EMBODIMENTS

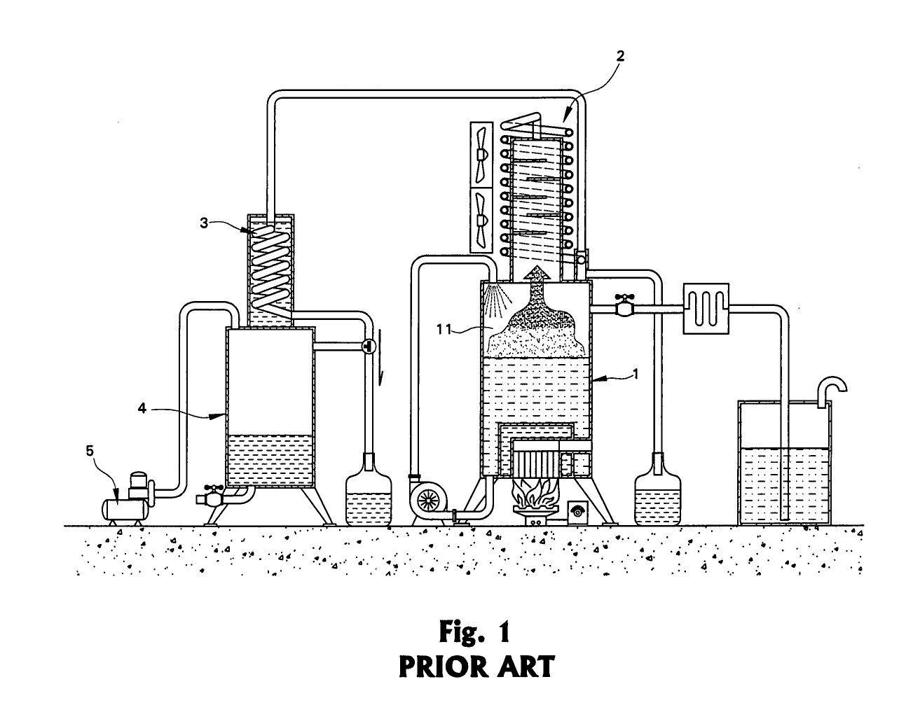

Referring to FIG. 1, a distilling apparatus for alcohol in accordance with the present invention comprises an evaporation tank 8 including a compartment 81 for receiving fermented alcoholic liquid 80. A heating tube 82 is provided in the compartment 81. In this embodiment, the heating tube 82 is helical and includes a first end 821 into which hot water flows and a second end 822. Located above the compartment 81 is a steam chamber 84 with a steam outlet 83. A plurality of separating plates 41 are alternately disposed in the steam chamber 84 to provide a plurality of vertically spaced and mutually communicated subchambers (not labeled) that define a winding path for the steam.

A circulating device 87 includes a circulating pump 871 that is connected to the compartment 81 via a tube 851. The tube 851 is connected to a refilling port 85 in a top wall delimiting the compartment 81. An outlet 86 is defined in a bottom wall delimiting the compartment 81 and communicated with the circulating pump 87 via a tube 861. Fermented alcoholic liquid 80 can be circulated in the compartment 81 when the circulating pump 87 operates. A storage tank 7 is communicated with an upper portion of the compartment 81 via a tube 71 such that fermented alcoholic liquid 80 can be fed into the evaporation tank 8. A preheating means 712 can be mounted in the tube 71 for preheating fermented alcoholic liquid to be fed into the evaporation tank 8.

The distilling apparatus further includes at least one condenser. In this embodiment, a first condenser 2 and a second condenser 3 are provided. The first condenser 2 includes a condenser tube 21 helically surrounding the steam chamber 84 and two fans 22 for air cooling. The condenser tube 21 includes an inlet 211 communicated with the steam outlet 83 of the evaporation tank 8 and an outlet 212. The second condenser 3 includes a condenser tube 31 helically mounted in a water tank 33 for proceeding with water cooling. The condenser tube 31 includes an inlet 311 communicated with the outlet 212 of the first condenser 2 and an outlet 312.

The distilling apparatus further comprises a collecting device 4 including at least one collecting tank 41. The collecting tank 41 includes a space 411 for receiving distilled alcohol 40. Defined in a top wall of the collecting tank 41 is an inlet 412 communicated with the outlet 312 of the second condenser 3. Also defined in the top wall of the collecting tank 41 is a vent 413.

The distilling apparatus further comprises a negative pressure creating device 5 that is communicated with the vent 413 of the collecting tank 41 by a pipe 51. The negative pressure creating device 5 can be an air compressor that draws air out of the collecting tank 41.

The distilling apparatus further comprises a solar heating device 9. The solar heating device 9 comprises a solar energy collector 91 and a water tank 92 connected to the solar energy collector 91 by a cold tube 95 and a hot tube 96. The water tank 92 includes a hot water outlet 921 communicated with the first end 821 of the heating tube 82 via a tube 93. The water tank 92 further includes a cold water inlet 922 communicated with the second end 822 of the heating tube 82 via a tube 94.

In operation, the negative pressure creating device 5 draws air out of the collecting tank 41 such that a negative pressure (about 500-700 mmHg) is created in the collecting tank 41 and in the evaporation tank 8. Thus, the fermented alcoholic liquid 80 in the evaporating tank 8 evaporates at a relatively low temperature (about 30-40° C.).

The temperature of hot water in the water tank 92 may reach up to 65° C. after absorbing the radiation heat from the sun. The hot water in the water tank 92 enters the heating tube 82 via the tube 93 to heat the fermented alcoholic liquid 80 in the evaporation tank 8. Since the heating tube 82 in the evaporation tank 8 is helical and thus has a relatively large surface area for heat transfer, the fermented alcoholic liquid is heated and evaporates into steam. The steam is condensed after passing through the first condenser 2 and the second condenser 3. The condensed distilled alcoholic 40 is collected in the collecting device 4.

The hot water in the water tank 92 passes through the second end 822 of the heating tube 82 into the cold water inlet 922 of the water tank 92 via the tube 94. Since the cold water entering the water tank 92 has a larger density, the cold water will flows toward the solar energy collector 91 to absorb the radiation heat from the sun. The temperature of the cold water rises and thus becomes hot water having a smaller density. The hot water flows upward into the water tank 92 via a hot water circulating tube 96. Meanwhile, hot water flows out of the hot water outlet 921 into the heating tube 82 via the tube 93, forming a natural circulation.

A pump (not shown) may be provided to force the hot water from the water tank 92 into the heating tube 82 for heating the fermented alcoholic liquid. Further, the cold water exiting the heating tube 82 flows into the solar energy collector 91 to absorb the radiation heat and then flows back into the water tank 92. An auxiliary heating device (such as an electric heater) can be used in rainy days or cloudy days.

The heat consumption of the distilling apparatus in accordance with the present invention using solar energy is relatively low as compared to the conventional distilling apparatuses, as the heating tube 82 is supplied with hot water heated by solar energy and as the fermented alcoholic liquid evaporates at a relatively low temperature by means of using the negative pressure creating device 5. The concentration of the distilled alcohol fulfills the product need and the flavor of the distilled alcohol is excellent.

It is noted that the fermented alcoholic liquid 80 in the evaporation tank 8 transforms into steam after heating. The steam enters the steam chamber 84 of the evaporation tank 8, and the temperature of the team is lowered after passing through the winding path defined by the separating plates 841. When the temperature of the steam is lowered to a critical point, the steam turns into liquid drops which are heated by the heated fermented alcoholic liquid and becomes steam again. Repeated distillation generates distilled alcohol with excellent quality. Further, the circulating pump 871 provides circulation of the fermented alcoholic liquid in the evaporation tank 8 and thus allows excellent heat exchange while preventing deposition of residue and impurities. Further, impact of the alcoholic liquid streams during the circulation assists in release of aldehydes.

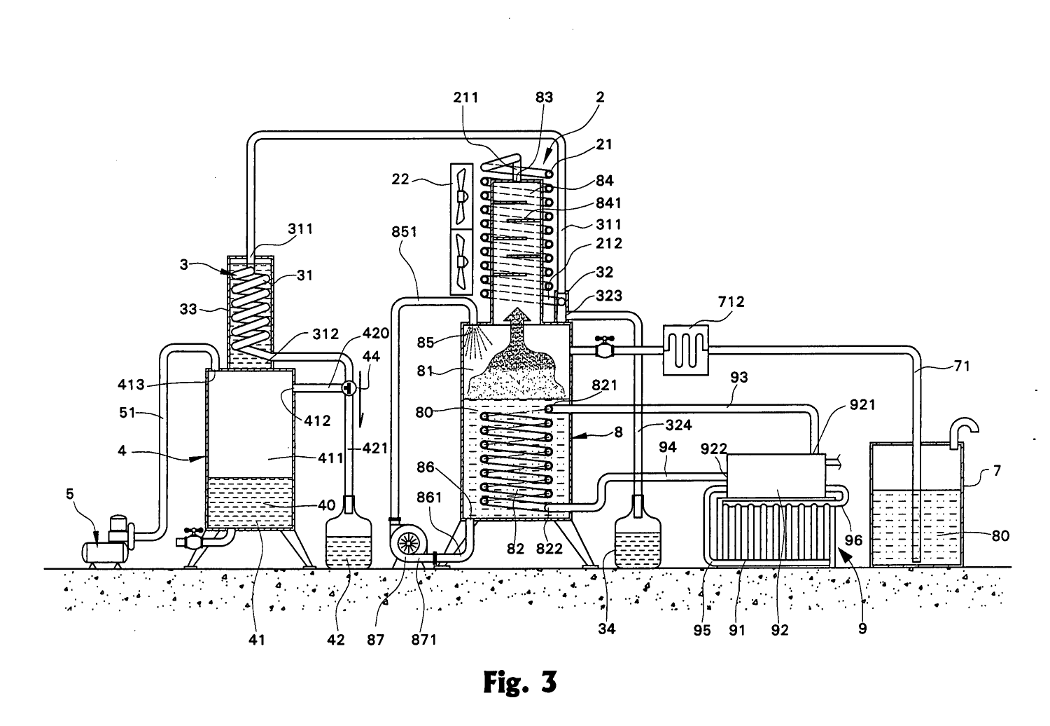

FIG. 3 illustrates a modified embodiment of the distilling apparatus in accordance with the present invention, wherein a sealed aldehyde collecting container 34 is provided. The aldehyde collecting container 34 is communicated with the first condenser 2 via a tube 324, with a three-way valve 32 being mounted to a coupling joint between the tube 324 and the second condenser 2. When the steam passes through the first condenser 2, gaseous aldehydes condense into liquid and flow into the aldehyde collecting container 34 via a port 323 of the three-way valve 32 and the tube 324. The uncondensed steam (i.e., relatively heavier alcohols) after passing through the first condenser 2 is guided into the second condenser 3 under the action of negative pressure.

Further, the collecting device 4 includes a second collecting tank 42. The second collecting tank 42 is communicated with the second condenser 3 via a tube 421, and the tube 421 is communicated with the first collecting tank 42 via a tube 420. A control valve 44 is mounted to a coupling point between the tube 421 and the tube 420, allowing selective communication between the first and second collecting tanks 41 and 42 and the second condenser 3. The second collecting tank 42 receives methyl alcohol from the second condenser 3 that condenses first. When the liquid collected in the second collecting tank 42 reaches a certain level, the control valve 44 is switched to allow communication between the second condenser 3 and the first collecting tank 42 while cutting communication between the second condenser 3 and the second collecting tank 42. The ethyl alcohol (i.e., distilled alcohol) is accumulated in the first collecting tank 42.

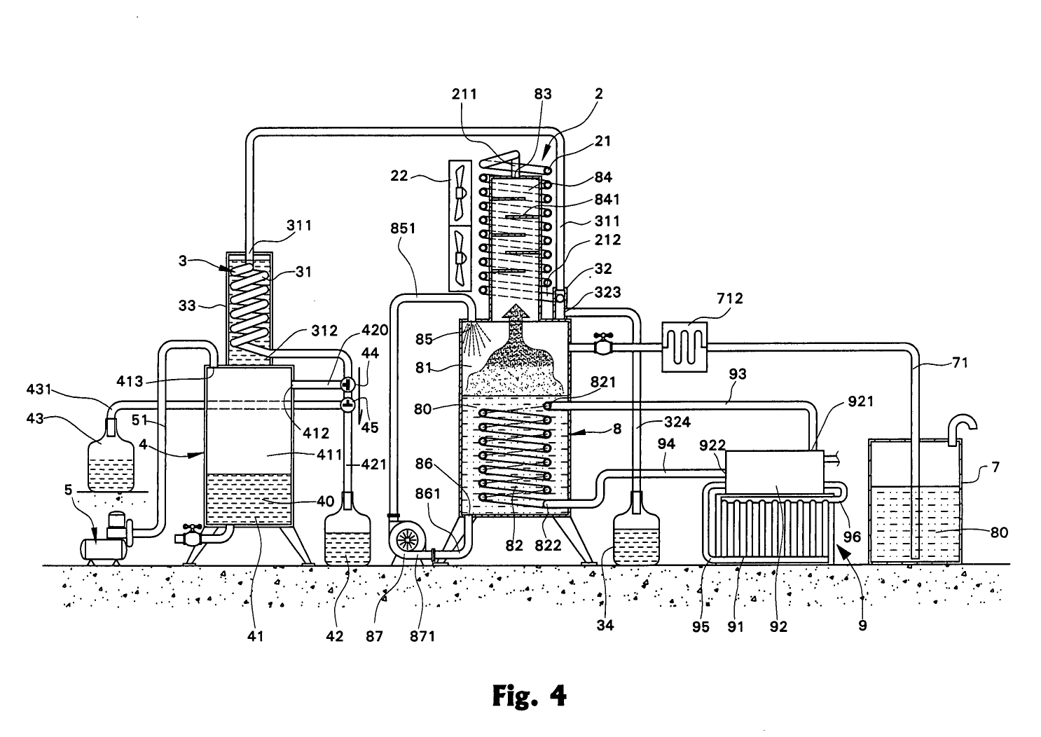

FIG. 4 illustrates another embodiment modified from the embodiment of FIG. 3. In this embodiment, a third collecting tank 43 is provided. The third collecting tank 43 is communicated with the tube 421 via a tube 431, with a control valve 45 being mounted to the coupling point between the tube 431 and the tube 421. This arrangement can be used to collect alcohols of different concentration in separate collecting tanks 41 and 43. More specifically, when the distilled alcohol in the first collecting tank 41 reaches a certain level, the control valve 45 is switched to communicate the second condenser 3 with the third collecting tank 43 while cutting communication between the second condenser 3 and the second collecting tank 42 and cutting communication between the second condenser 3 and the first collecting tank 41. Thus, the third collecting tank 43 may receive alcohol with a lower concentration.

Although specific embodiments have been illustrated and described, numerous modifications and variations are still possible without departing from the essence of the invention. The scope of the invention is limited by the accompanying claims.

What is claimed is:

1. A distilling apparatus for alcohol comprising:
an evaporation tank comprising a compartment for receiving fermented alcoholic liquid, a heating tube being mounted in the compartment for heating the fermented liquid into steam;
a condensing device communicated with the evaporation tank, the condensing device receiving and condensing steam from the evaporation tank;
a collecting tank communicated with the condensing device for collecting condensed liquid from the condensing device;
a negative pressure creating device for creating a negative pressure in the evaporation tank, allowing the fermented alcoholic liquid in the evaporation tank to evaporate at a low temperature; and
a solar energy collecting device comprising a solar energy collector and a water tank containing water heated by the solar energy collector, hot water in the water tank flowing into the heating tube for heating the fermented alcoholic liquid in the evaporation tank.

2. The distilling apparatus for alcohol as claimed in claim 1, with the heating tube being helical.

3. The distilling apparatus for alcohol as claimed in claim 1, with the heating tube including a first end and a second end, with the water tank including a hot water outlet communicated with the first end of the heating tube, and with the water tank including a cold water inlet communicated with the second end of the heating tube.

4. The distilling apparatus for alcohol as claimed in claim 1, with the condensing device comprising a first condenser and a second condenser mounted between the first condenser and the collecting tank, the evaporation tank including a steam chamber located above the compartment, the first condenser including a helical condensing tube.

5. The distilling apparatus for alcohol as claimed in claim 4, with the second condenser including a water tank and a helical condensing tube mounted in the water tank.

6. The distilling apparatus for alcohol as claimed in claim 1, with the distilling apparatus further comprising means for circulating fermented liquid in the evaporation tank.

7. The distilling apparatus for alcohol as claimed in claim 6, with the means for circulating fermented liquid including a pump, a first tube connected between an inlet of the pump and a bottom portion of the evaporation tank, and a second tube connected between an outlet of the pump and a top of the compartment of the evaporation tank.

8. The distilling apparatus for alcohol as claimed in claim 1, with the distilling apparatus further comprising a second collecting tank for collecting methyl alcohol, with the collecting tank collecting ethyl alcohol.

9. The distilling apparatus for alcohol as claimed in claim 4, with the second collecting tank being communicated with the second condenser via a first tube, with the collecting tank being communicated with the first tube via a second tube, and with a first control valve being mounted to a coupling point between the first tube and the second tube for providing selective communication between the second condenser and the collecting tank and between the second condenser and the second collecting tank.

10. The distilling apparatus for alcohol as claimed in claim 9, with the distilling apparatus further comprising a third collecting tank for collecting ethyl alcohol with a concentration lower than that in the collecting tank.

11. The distilling apparatus for alcohol as claimed in claim 10, with the third collecting tank being communicated with the first tube via a third tube, and with a second control valve being mounted to a coupling point between the first tube and the third tube, providing selective communication between the second condenser and the second collecting tank and between the second condenser and the third collecting tank.
